(19) United States
(12) Patent Application Publication
(10) Pub. No.: US 2019/0292680 A1
(43) Pub. Date: Sep. 26, 2019

(54) ELECTRO-CERAMIC COATING BATH CLEANUP BY A HYBRID ION EXCHANGE PRECIPITATION PROCESS

(71) Applicant: Henkel AG & Co. KGaA, Duesseldorf (DE)

(72) Inventors: William G. Kozak, Waterford, MI (US); Eric C. Kuhns, Jr., Washington, MI (US); Klaus Lepa, Troisdorf (DE)

(21) Appl. No.: 16/438,988

(22) Filed: Jun. 12, 2019

Related U.S. Application Data
(63) Continuation of application No. PCT/US2017/068658, filed on Dec. 28, 2017.
(60) Provisional application No. 62/440,024, filed on Dec. 29, 2016.

(51) Int. Cl. C25D 21/22; C25D 11/08; C25D 11/02; B01D 15/36; B01D 15/20; B01J 39/05; B01J 39/18; B01J 47/02; B01J 49/06; B01J 49/53

(52) U.S. Cl. CPC C25D 21/22; C25D 11/08; C25D 11/026; B01D 15/362; B01D 15/203; C25D 11/024; B01J 39/18; B01J 47/02; B01J 49/06; B01J 49/53; B01J 39/05

(57) ABSTRACT

A process and a system for cleaning excess aluminum from coating baths, e.g. anodization bath solutions, so that they can be reused in an effective manner is provided. The process comprises first passing a portion of the anodization bath solution having excess aluminum through a strong acid cation exchange column in a Na+ form, allowing the effluent to age thereby precipitating cryolite from the effluent; removing the precipitated cryolite from the effluent and then passing the effluent through a strong acid cation exchange column in the NH4+ form, in a preferred embodiment back through the first column, to restore NH4+ to the anodization bath solution and then adding the effluent back in to the anodization bath solution.

### RELATED APPLICATIONS

### Technical Field

This invention relates generally to coating bath solutions and more particularly to coating baths, e.g. electrolytes used in electrolytic deposition, and a method and system for removing contaminants from coating bath solutions.

### Background of the Invention

Aluminum and aluminum alloys are used to create a wide variety of consumer goods and machine parts. Because aluminum and its alloys are very reactive and subject to corrosion it is desirable to apply coatings to the aluminum surfaces to provide corrosion, heat and abrasion resistance to the surfaces of these consumer goods and machine parts. The coatings may be formed from aqueous acidic solutions that dissolve some aluminum (and other metals) from substrate surfaces into the coating bath. In some processes the coating baths include materials that form water-soluble complexes with the aluminum, such that the aluminum does not form much sludge but remains in the bath. Particularly where coating baths contain aluminum, titanium and fluorine, the bath may build up aluminum-fluoride complexes to a level that interferes with coating. Coating baths that have this dissolved aluminum buildup include those used with or without the application of electromotive force.

Typically, these coatings may be applied by anodization, plasma electrolytic oxidation, micro arc oxidation, microplasma oxidation and similar processes. For example, one electrolytic coating process uses a bath containing dissolved components of complex fluorides and oxyfluorides of Ti, Zr, Hf, Sn, Ge, B, and mixtures thereof in the presence of phosphorous containing acids, phosphorous containing salts and mixtures thereof. Other dissolved components in the electrolytic coating bath can include: oxysalts of Zr, V, or Ti; salts of Nb, Mo, Mn and W; and alkali metal hydroxides or fluorides. This process is also often known as an electro ceramic coating process. In the present specification and claims the terms “anodization plasma process” and “electro ceramic coating process” refer to the same anodization process. In brief the process involves providing a cathode in contact with the anodizing solution, placing the article to be coated as the anode in the anodizing solution and passing a current through the anodizing solution at a voltage and for a time effective to form the coating on the surface. One can use direct current, pulsed direct current or alternating current with pulsed direct current or alternating current being preferred. Basic anodization plasma processes are disclosed in U.S. Pat. Nos. 7,569,132 and 8,663,807 which are whereby incorporated by reference. Most often the desired ceramic coating comprises titanium and/or zirconium oxide coatings. The anodization solutions have specific parameters that must be adhered to in terms of various contaminants and their concentrations need to be monitored.

When depositing a ceramic coating on aluminum parts using an anodization plasma process, aluminum (Al) gradually accumulates in the coating bath solution. In the present specification and claims the term aluminum parts refers to both pure aluminum parts and aluminum alloy parts unless noted otherwise, and likewise applies to parts coated with aluminum or its alloys. The aluminum that accumulates in the bath comes from the aluminum part as a result of etching that takes place during the anodization plasma process. Eventually the concentration of aluminum in the coating bath solution reaches a high enough concentration and causes the properties of the applied ceramic coating to deteriorate which in turn requires the bath solution to be disposed of. This leads to increased costs, waste and low efficiency of transfer of the desired ceramic onto the aluminum parts.

One problem discovered in attempting to remove dissolved aluminum-fluoride complexes from a coating bath containing dissolved titanium-fluoride complexes is that many separation methods do not distinguish between the two types of complexes. These separation methods remove both Al and Ti from the coating bath, which is an unacceptable result where Ti is a desired coating component. Prior attempts to selectively remove the aluminum by various single-step processes such as ion exchange, diffusion dialysis, crystallization or precipitation have all failed.

Thus, it would be desirable to create an economical, straight forward method and system for removing aluminum from electro ceramic coating bath solutions. Preferably the system and method could be implemented on existing coating systems with few changes to the process and most preferably it would function in a method that would not require shutting down of the electro ceramic coating line.

### SUMMARY OF THE INVENTION

In general terms, this invention provides an economical system and method for removing aluminum from coating baths, e.g. an electro ceramic coating bath solution, and restoring the bath solution to a usable condition. This allows the bath life to be extended far beyond currently available life times. The process is highly effective and permits more efficient utilization of the coating composition. Although the process and apparatus are described with reference to removing aluminum from an electrolyte, those of skill in the art will recognize that the invention may be used for removing aluminum from other aqueous coating baths having similar chemistry.

An object of the invention is to provide a method for removing aluminum from coating bath, e.g. an anodization bath, solution comprising the steps of:

a) providing an aqueous acidic coating bath solution containing NH₄⁺ and dissolved aluminum;
b) passing the coating bath solution through a strong acid cation exchange column in the Na⁺ form and exchanging Na⁺ for NH₄⁺ in the coating bath solution thereby generating a first effluent and collecting the first effluent;
c) removing insoluble cryolite, Na₃AlF₆, solids from the first effluent of step b) thereby forming a supernatant effluent; and
d) passing the supernatant effluent from step c), after removal of the cryolite, through a strong acid cation exchange column in the NH₄⁺ form and exchanging NH₄⁺ for Na⁺ in the supernatant effluent thereby generating a second effluent and collecting the resulting second effluent.

The cryolite forms over a period of time and thus the effluent from step b) may be aged for a period time sufficient to allow for formation of the cryolite. Desirably, this period of time can be as short as 1 hour and can extend to 5 hours or more than 5 hours.

In some embodiments, the method further comprises a step prior to step a) of removing a selected amount of an aqueous acidic anodization solution containing NH₄⁺ and dissolved aluminum from a bath or other source, providing the selected amount as the aqueous acidic solution of a) and after performing steps b)-d) described above, performing additional step e) returning the second effluent to the bath or other source and optionally f) replenishing the bath.

According to one aspect of the present invention (“Aspect 1”), a method is provided for removing aluminum from an anodization bath solution comprising the steps of:
a) providing an aqueous acidic anodization solution containing NH₄⁺ and aluminum and fluoride;
b) passing the anodization solution through a strong acid cation exchange column in the Na⁺ form and exchanging Na⁺ for NH₄⁺ in the anodization solution and collecting the effluent;
c) removing formed insoluble cryolite, Na₃AlF₆, from the effluent of step b); and
d) taking the effluent from step c), after removing the cryolite, and passing it through a strong acid cation exchange column in the NH₄⁺ form and exchanging NH₄⁺ for Na⁺ in the effluent and collecting the resulting effluent.

Further aspects of the invention may be summarized as follows:

Aspect 2: The method of Aspect 1, wherein the anodization solution comprises water-soluble complex fluorides and/or oxyfluorides of elements selected from the group consisting of Ti, Zr, Hf, Sn, Al, Ge, B, and mixtures thereof; and wherein the anodization solution further comprises phosphorous containing acids, salts or mixtures thereof.

Aspect 3: The method of any one of Aspects 1 and 2, wherein the anodization solution in step a) contains more than 200 parts per million (ppm) of aluminum.

Aspect 4: The method of any of Aspects 1-3, wherein the cation exchange column in step b) comprises from 0.05 to 1.0 liters of cation exchange resin per gram of aluminum to be removed from the anodization solution from step a).

Aspect 5: The method of any of Aspects 1-4, wherein a rate of flow of the anodization solution through the cation exchange column in step b) is from 2 to 50 bed volumes per hour.

Aspect 6: The method of any of Aspects 1-5, wherein removal of cryolite in step c) comprises either filtering the cryolite from the effluent or separation from the effluent by a centrifugation process.

Aspect 7: The method of any of Aspects 1-6, wherein step c) further comprises aging the effluent from step b) in a tank for a period of time of at least 1 hour to allow for formation of the cryolite in the effluent prior to removing it in step c).

Aspect 8: The method of Aspects 7, wherein said period of time of aging the effluent from step b) comprises a sufficient amount of time to allow for formation of cryolite particles having a size of from 0.1 to 50 microns.

Aspect 9: The method of any of Aspects 1-8, wherein step d) comprises passing the effluent from step c) through the same cation exchange column as in step a), which was has been regenerated to be in the NH₄⁺ form, to exchange NH₄⁺ for Na⁺ in the effluent and collecting the resulting effluent.

Aspect 10: The method of Aspect 9, wherein the anodization solution in step a) is passed through the cation exchange column in a first direction and wherein the effluent from step d) is passed through the same cation exchange column in a counter current direction to step a).

Aspect 11: The method of any of Aspects 1-10, further comprising passing the effluent from step b) through a Na⁺ polishing ion exchange column prior to step c).

Aspect 12: The method of any of Aspects 1-11, further comprising passing the resulting effluent from step d) through a NH₄⁺ polishing ion exchange column.

Aspect 13: The method of any of Aspects 1-12, wherein the cation exchange column in step a) is a different cation exchange column from the cation exchange column utilized in step d).

Aspect 14: The method of any of Aspects 1-13, further comprising the step of regenerating the cation exchange column from step a) to the Na⁺ form by passing a regenerating solution containing at least one regenerant salt selected from the group consisting of NaCl, Na₂SO₄, NaHSO₄, Na₃PO₄, Na₂HPO₄, NaH₂PO₄, and mixtures thereof through the cation exchange column.

Aspect 15: The method of Aspect 14 wherein an equivalents excess of regenerant equivalents to cation resin equivalents is in a range of from 1-fold to 10-fold excess.

Aspect 16: The method of Aspect 14, wherein a flow rate of the regenerating solution through the cation exchange column is from 2 to 50 bed volumes per hour.

Aspect 17: The method of any of Aspects 1-16, further comprising the step of regenerating the cation exchange column from step d) to the NH₄⁺ form by passing a regenerating solution containing at least one regenerant salt selected from the group consisting of (NH₄)₂HPO₄, (NH₄)H₂PO₄, (NH₄)₂SO₄, (NH₄)HSO₄, (NH₄)Cl, and mixtures thereof through the cation exchange column.

Aspect 18: The method of Aspect 17, wherein an equivalents excess of regenerant equivalents to cation resin equivalents is in the range of from 1-fold to 10-fold excess.

Aspect 19: The method of Aspect 17, wherein a flow rate of the regenerating solution through the cation exchange column is from 2 to 50 bed volumes per hour.

Aspect 20: The method of any of Aspects 1-19, wherein the resulting effluent after step d) has an aluminum content of from 200 to 3000 parts per million.

Aspect 21: The method of Aspect 14, further comprising a periodic step of regenerating the cation exchange column from step a) with HCl thereby removing precipitated cryolite from the cation exchange column followed by neutralizing with NaOH or NH₄OH thereby regenerating to the Na⁺ form or NH₄⁺ form.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a schematic of an anodization bath system prior to addition of a bath cleaning system according to the present invention;

FIG. 2 is a schematic of one embodiment of the present invention showing the bath cleaning system added to the anodization bath system of FIG. 1;

FIG. 3 is a schematic of another embodiment of the present invention showing use of a countercurrent ion exchange column and two polishing columns in combination as a bath cleaning system with the anodization bath system shown in FIG. 1;

FIG. 4 is a schematic of another embodiment of the present invention showing use of a countercurrent ion exchange column in a bath cleaning system with the anodization bath system shown in FIG. 1;

FIG. 5 is a schematic of another embodiment of a bath cleaning system of the present invention that includes two ion exchange columns in combination with the anodization bath system of FIG. 1 and a series of transfer pumps;

FIG. 6 is a Scanning Electron Micrograph picture at 850× magnification, of the precipitate from Example 1, the bar is 20 microns in length;

FIG. 7 is a graph showing loss/retention of Ti and Al in the samples recovered from an ion exchange column in Example 2 in accordance with the present invention;

FIG. 8 is a graph showing the pH of samples from Example 2 after passing through an ion exchange column in accordance with the present invention;

FIG. 9 is a graph showing the ratio of effluent to feed liquid concentration for Ti and Al during the use of the cleaning process in accordance with the present invention in a larger column than Example 2; and

FIG. 10 is a graph showing the pH of samples from Example 3 first after passing through an ion exchange column and second after precipitation in accordance with the present invention.

### DETAILED DESCRIPTION OF A PREFERRED EMBODIMENT

Electro ceramic coating baths have stringent quality requirements that can only be met by maintaining the concentrations of various impurities below certain concentrations. One such impurity is aluminum which is etched from the aluminum parts and which accumulates at a rate of about 1.5-5.5 gm/m² or more in the bath depending upon the processing parameters. At an aluminum concentration of about 1000-2500 ppm (1 to 2.5 gm/L) and higher in coating baths, e.g. electro ceramic coating baths, depending on the specific part or alloy, the coating quality deteriorates. At this point, the bath has historically been dumped and recharged with new solution resulting in increased raw material consumption and cost, downtime on high production lines, and waste disposal issues. With typical processes, even with optimized bath conditions, only about 30 wt. %, based on total weight of titanium from raw materials added to the bath, becomes part of the coating deposited on the parts. The process of the present invention selectively removes aluminum from the bath thereby indefinitely extending its life and preserving the expensive titanium in the bath for deposition on aluminum parts. By increasing bath life and keeping the raw material titanium in the bath, the inventive cleaning process can more than double the percentage of the titanium from raw materials that is deposited on the parts, meaning greater than about 60 wt. % of the titanium from the raw materials added to the bath will become part of the coating. Generally, about 40 wt. % of titanium added to the bath is lost with drag-out liquid that exits the bath with the coated part and sludge. As such, deposition of about 60 wt. % of the raw material titanium is use of nearly all available titanium for coating, considering drag out and sludge. The drag out can be reduced by various means that are not addressed herein.

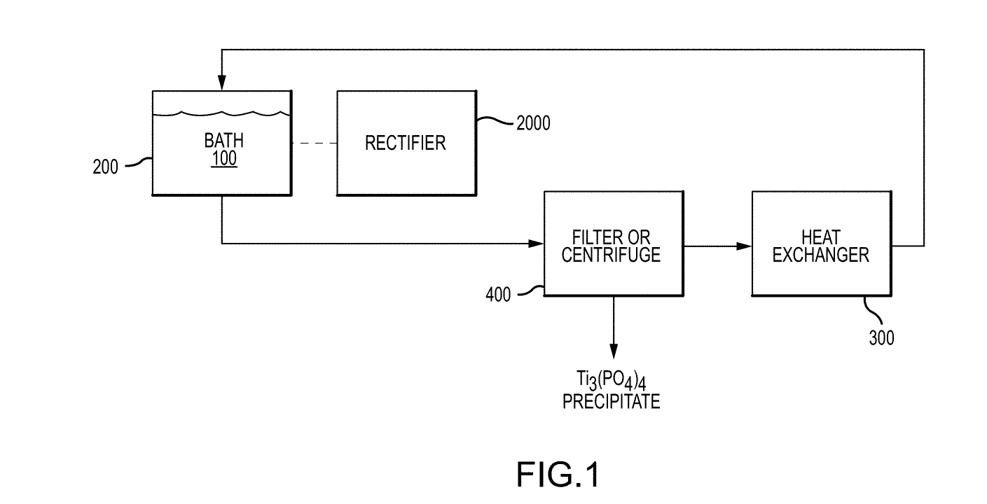

A basic anodization process system, with which the method and system of the invention may be used, is depicted as a coating bath schematic in FIG. 1. Aluminum parts are immersed in an acidic aqueous anodization bath solution 100 in the coating bath tank 200. The anodization bath solution 100 contains fluorotitanate species, such as for example TiF₆⁻² species, phosphate PO₄⁻³ species and ammonium, NH₄⁺ and H⁺ counter ions. The aluminum part acts as the anode in the bath and stainless steel acts as the cathode. Multiple aluminum parts can be placed in the tank at one time. The rectifier 2000 is electrically connected to the anode and the cathode in the bath solution 100; the rectifier is turned on to provide the electrical current to the bath and a non-stoichiometric coating of titanium dioxide, often with trace elements of Al, P and F is deposited on the aluminum part(s). A tremendous amount of energy is generated by the anodization plasma process, so the bath solution desirably is continuously circulated, preferably at a high rate, through a heat exchanger 300 to keep the temperature at the proper operating temperature. Insoluble salts, mostly titanium phosphate Ti₃(PO₄)₄ are formed at the cathode(s) in the bath and are removed by passing the bath through a solids separation device 400, e.g. a filter and/or a centrifuge as shown in FIG. 1. Some aluminum is dissolved from the parts and gradually accumulates in the solution, typically as the anion, AlF₅⁻². The anodized or electro ceramic coatings are applied under conditions as disclosed in U.S. Pat. Nos. 7,569,132 and 8,663,807 which are hereby incorporated by reference, but other coating processes, particularly industrial coating processes with buildup of soluble aluminum-fluoride species in the coating baths may benefit from use of the inventive cleaning process.

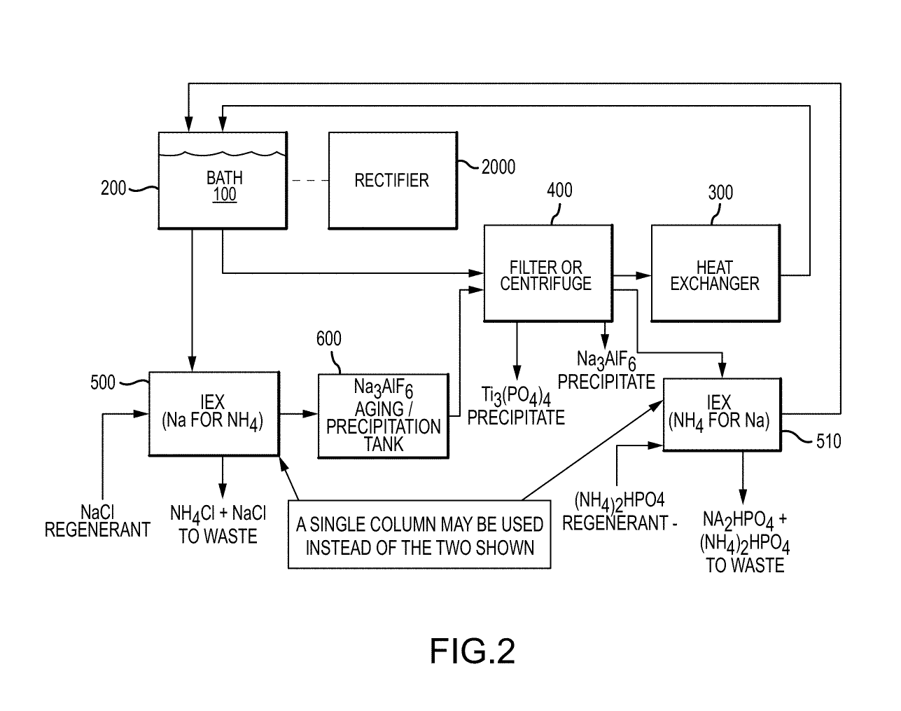

The present process typically is a four or five step process for restoring an anodization bath solution having high concentrations of aluminum back to a working anodization bath solution with greatly reduced concentrations of aluminum, without removing significant amounts of titanium. As shown diagrammatically in FIG. 2, in a first step of this process, the primary cation in the bath solution, ammonium (NH₄⁺) largely in the form of ammonium hexafluoroaluminate (NH₄)₃AlF₆, is first ion exchanged with the cation Na⁺ by passing the bath solution through a strong acid cation exchange resin having Na⁺ present as the exchange ion, typically in a resin bed or IEX column 500. This step removes NH₄⁺ and add Na⁺ thereby forming a first effluent. In a second step, the Na⁺ released into the first effluent then precipitates the dissolved aluminum out after a period of time as insoluble precipitate comprising, preferably consisting essentially of or consisting of cryolite, Na₃AlF₆, because it is very insoluble in the bath solution and first effluent liquids. The cryolite is very insoluble compared to the ammonium hexafluoroaluminate, (NH₄)₃AlF₆, which was the form much of the aluminum was in within the original bath solution. The precipitation of cryolite generally may take place in precipitation tank 600. “Cryolite” as used herein encompasses both Na₃AlF₆ and first effluent insoluble precipitates comprising Na₃AlF₆ with some other insoluble materials, preferably with low levels of Ti and PO₄. In a third step, the precipitated cryolite is then removed from the first effluent bath solution by passing the first effluent through a solids separation device 400, e.g. a filter and/or a centrifuge 400, for filtration or centrifugation thereby forming a filtrate or centrate liquid, also referred to herein as a supernatant liquid. In a fourth step, the Na⁺ is removed from the filtrate or centrifugation centrate by passing the solution through a second strong acid cation exchange resin having NH₄⁺ as the exchange ion, shown as IEX column 510 in FIG. 2, whereby the NH₄⁺ is added to the supernatant liquid, i.e. put back for return to in the bath solution and the Na⁺ is removed forming a second effluent. In the fifth step, the second effluent is returned to the coating tank 200 or other reservoir for re-use in the bath solution. This process allows the bath life to be extended almost indefinitely or for at least an additional 50, 75, 100, 125, 150, 175, 200, 250, 300, 350, 400, 500 or more percent of bath life, measured as a non-IEX cleaned bath of the same or similar initial chemistry.

When using the inventive process, after IEX treatment, it is desirable to include in the process, a step to test the concentrations in the resulting effluent and/or the coating bath. Desirably one may test concentrations of the active components of the ceramic coating composition such as the complex fluorides and oxyfluorides of Ti, Zr, Hf, Sn, Ge and B and any other critical bath components, in particular those to be incorporated in the finalized ceramic coating on the aluminum part in order to achieve a return to good coating deposition.

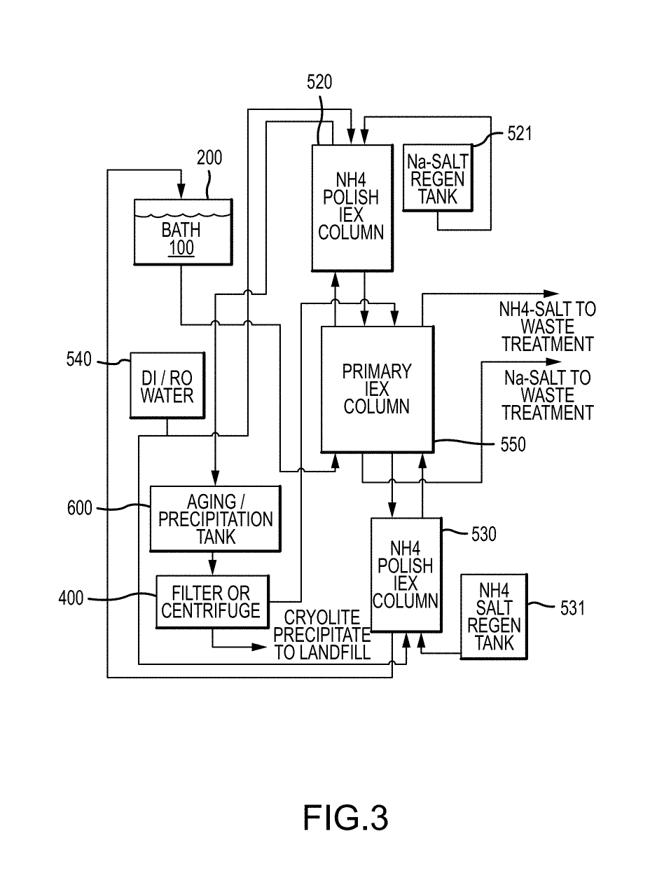

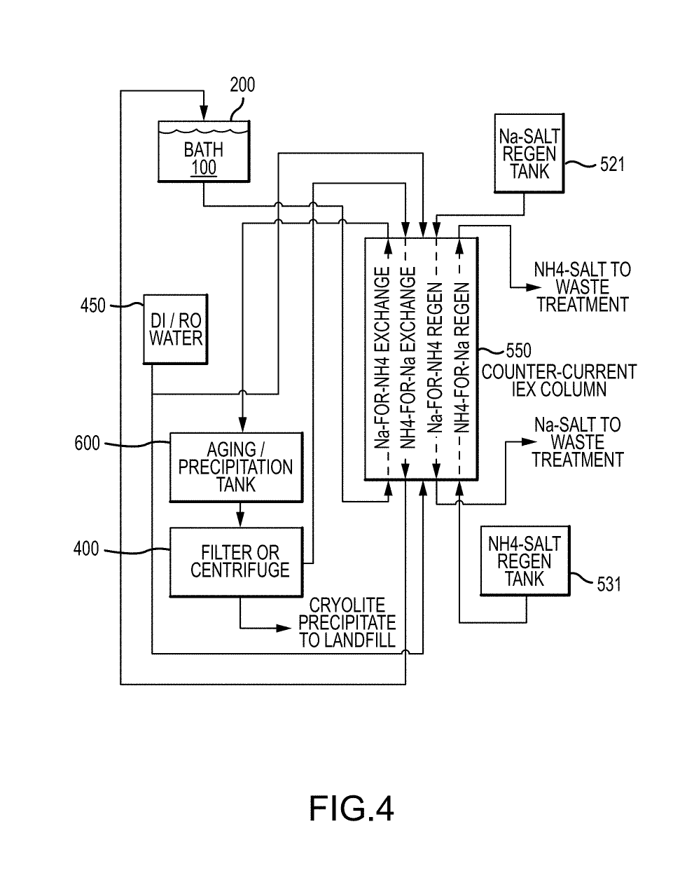

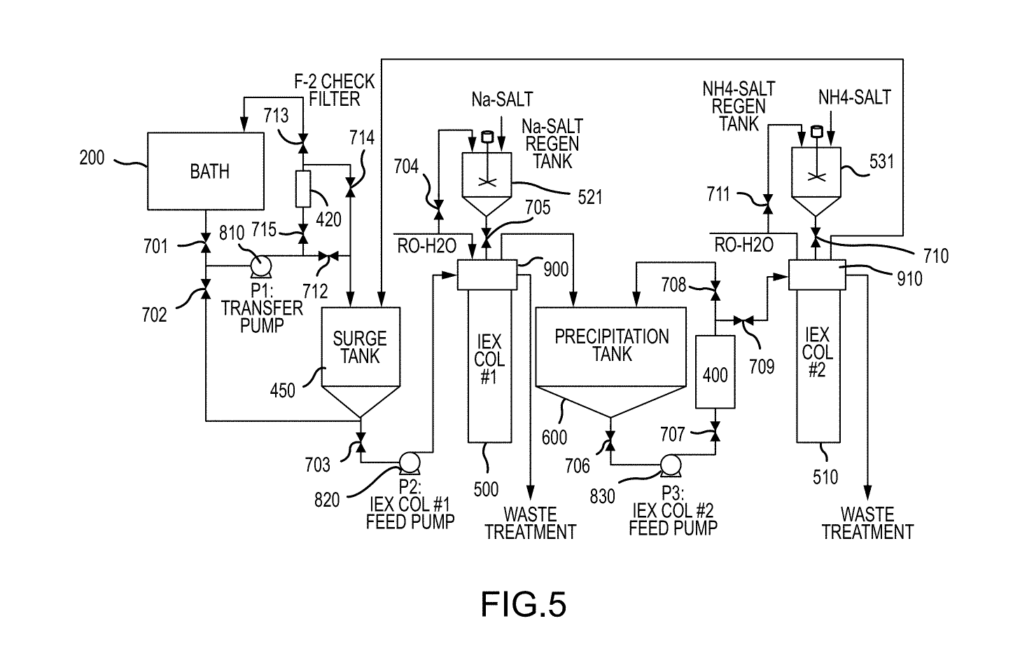

The process can be run using a single strong acid cation exchange column 550 that starts out in the Na⁺ form and using a counter current flow through the column 550 (see for example FIGS. 3 and 4) or it can be accomplished using two strong acid cation exchange columns 500 and 510, one in the Na⁺ form 500 and another in the NH₄⁺ form 510 (see for example FIGS. 2 and 5). The process results in a dramatic reduction of aluminum with minimal loss of other components in the anodization solution. The process can also comprise utilization of Na⁺ and NH₄⁺ polishing columns, 520 and 530 respectively, as shown in FIGS. 3 and 5, which may be used to even further reduce aluminum concentration.

A schematic of a system for carrying out the inventive process utilizing two ion exchange columns 500 and 510 is shown in FIG. 2. With this improved process and apparatus schematically shown in FIG. 2, a portion of the coating bath solution 100 from the bath tank 200 is transferred to a separate aluminum removal system, that is operated in a batch mode. The aluminum removal system or aluminum removal portion of the total coating system is desirably hydraulically connected to the bath tank 200 by flow paths having valves 700 and 713 enabling removal of coating bath 100 from the tank and return of cleaned bath to the tank as shown in FIG. 5. The exact amount of the bath solution to be transferred depends on several variables such as the total surface area of the aluminum parts being coated per day, the aluminum accumulation rate per unit area (Al gm/m²), and desired concentration of aluminum in the bath.

As shown in FIG. 2 in the first step of this aluminum removal process, a portion of the coating bath is pumped through a first ion exchange column (IEX) column 500 filled with a strong acid cation resin in the Na⁺ form. In this column, the NH₄⁺ ions are removed from the coating bath solution and replaced with Na⁺ ions. The anions in solution, when using titanium as the metal for the ceramic coating, are mostly compounds such as by way of non-limiting example fluorotitanate TiF₆⁻², monohydrogen phosphate HPO₄⁻², and hexafluoroaluminate AlF₆⁻³ and these species pass through the column without being removed from the feed by the IEX resin. That is, these species remain in the first effluent at about 75, 80, 85, 90, 95, 98 or 99 percent of what is found in the feed stock, less any dilution from rinsing of the IEX column. If using Zr, Hf, Sn, Al, Ge or B then these would be the fluoro anions that would pass through the column. The flow rate through the column should be fast enough to prevent or minimize any precipitation of Na₃AlF₆ within the resin bed to avoid plugging of the column. Once through the bed, the first effluent is collected and desirably is held for a period of time in an aging/precipitation tank 600. The first effluent is generally held in the precipitation/aging tank 600 for a period of time from 1 to 5 hours though longer times are not detrimental. During this period of time cryolite forms and precipitates out of the solution; the precipitate may be removed by a solids separation device 400, e.g. a filter and/or a centrifuge or the like, thereby forming a supernatant effluent. Depending on production schedules for the coating bath, the same solids separation device 400, e.g. a filter and/or a centrifuge that is used to remove the titanium phosphate solids from the bath solution may optionally be used to remove the cryolite precipitate from the aged IEX first effluent. However, the filtrates or centrates from these two feed streams should not be mixed together. The supernatant effluent from which the cryolite has been removed is then pumped through a second IEX column 510 containing a strong acid cation resin in the NH₄⁺ form. In this column, the Na⁺ ions are removed from the solution and replaced with NH₄⁺ ions thereby forming a second effluent before the second effluent is returned to the coating bath 100. In this second IEX column 510, the other anions in solution once again pass through the column without being removed from the supernatant effluent onto the IEX resin. That is, these species remain in the second effluent at about 75, 80, 85, 90, 95, 98 or 99 percent of what is found in the supernatant effluent, less any dilution from rinsing of the IEX column and are returned to the coating bath 100.

To reuse the resin in the IEX columns after a selected number of bed volumes or cleaning cycles, the IEX resin is regenerated. A Na⁺ salt is used to displace NH₄⁺ from the resin used in the first IEX column 500 and a NH₄⁺ salt is used to displace the Na⁺ from the resin used in the second IEX column 510. The exact choice of regenerating solution will depend on its cost, the potential for cross contamination of the bath with the counter ion, the ease of rinsing it from the resin bed, and the effectiveness of the actual cation exchange. In common IEX processes, the choices for the regenerants may be NaCl, to displace the NH₄⁺ ions from the first column, and NH₄Cl or (NH₄)₂SO₄, to displace the Na⁺ ions from the second column. Applicants have found that the most effective NH₄⁺ salts include the Cl⁻, hydrogen phosphates and SO₄⁻², with the Cl⁻ rinsing most effectively from the column. However, both Cl⁻ and SO₄⁻² are deleterious to some coating bath solutions, therefore more prudent regenerant choices may be those having counterions that are already part of the coating bath. For one embodiment of an electro ceramic coating process, regenerants may be Na₃PO₄, Na₂HPO₄, NaH₂PO₄, and mixtures thereof to displace the NH₄⁺ from the first column and other regenerants may be (NH₄)₂HPO₄, (NH₄)H₂PO₄, and mixtures thereof to displace the Na⁺ from the second column, where phosphate is already part of the coating bath solution and so small amounts of carryover from the IEX column regeneration is unlikely to contaminate the bath solution.

A variation of this process is shown in FIG. 3 that is particularly efficient in terms of raw material regenerant consumption is a countercurrent IEX conducted with a primary column 550 and then the inclusion of two polishing columns 520 and 530. As used herein, polishing columns will be understood to mean a secondary column, which may be used to further clean the first effluent after it leaves the primary column. Polishing columns may be the same size or smaller than the primary IEX column, and at least for the sake of economy the size and bed volume of the polishing columns may desirably be selected to be 50, 40, 30, 20 or 10% of the size of the primary IEX column. Polishing can be used to further reduce the concentration of Al as well as other ions, and the same or different IEX resin may be used in the polishing columns, preferably the same resin. In this embodiment of the process, the bulk of the Na⁺ exchange and NH₄⁺ exchange is done in the same column 550, but with the flows going in opposite directions. As shown in FIG. 3, the Na⁺ for NH₄⁺ exchange is done in an upward flowing direction through the primary IEX column 550 while the NH₄⁺ for Na⁺ exchange is done in a downward flowing direction through the primary IEX column 550. The rationale for the upward flow in the Na⁺ for NH₄⁺ exchange is that if any cryolite precipitates inside the IEX bed, it can be back flushed out of the bed. In the first upward flow through the primary IEX column 550, one passes the coating bath solution from the coating bath upward through the primary IEX column. This exchanges Na⁺ in the IEX resin with NH₄⁺ in the bath solution. After passing through the primary IEX column 550, the upward flowing first effluent then may be passed through a smaller Na⁺ polish column 520 before going to the aging/precipitation tank 600.

After precipitation of the cryolite, Na₃AlF₆, the contents of the aging/precipitation tank 600 are passed through a solids separation device 400, e.g. a filter and/or a centrifuge, subjected to filtering or centrifugation to remove the insoluble cryolite, forming a supernatant effluent. This completes the first half of the cleaning process. The second half of the cleaning process is then begun by taking the filtrate or supernatant from the centrifugation, i.e. supernatant effluent, and passing it, preferably downwardly, through the primary IEX column 550 thereby exchanging NH₄⁺ in the resin (derived from the coating bath in the first pass upward flow) for Na⁺, thereby producing a second effluent. The second effluent may then be passed through a smaller NH₄⁺ polish column 530 and finally the second effluent is returned to the coating bath tank 200 or sent to another reservoir, such as surge tank 450 shown in FIG. 5.

One advantage of this embodiment shown in FIG. 3 is that it effectively “stores” most of the ammonium ions removed from the bath in the primary IEX column 550 and “reuses” them as part of the NH₄⁺ salt regeneration, essentially recycling the ammonium ions from the bath, thereby reducing the consumption of fresh NH₄⁺ salt raw material. This system works particularly well because about half of the ammonium ions in the original bath solution are attached to the fluoroaluminate which is removed as cryolite. This means that there is about a 2-fold excess of NH₄⁺ ions to replace the Na⁺ ions associated with the fluorotitanate and hydrogen phosphate anions in the supernatant effluent from the aging/precipitation tank 600. Unlike in a typical IEX process, in this inventive system the primary IEX column 550 is typically not totally regenerated but rather varies from being mostly in the Na⁺ form, with some NH₄⁺ form near the bottom to mostly in the NH₄⁺ form with some Na⁺ form near the top. By way of contrast, the small Na⁺ polish column 520 is fully regenerated to the Na⁺ form and the small NH₄⁺ polish column 530 is fully regenerated to the NH₄⁺ form after each use. The polish columns, 520 and 530, and the primary IEX column 550 are rinsed with deionized (DI) or reverse osmosis (RO) water from DI/RO water source 540. The Na⁺ polish column 520 may be regenerated using Na-salts, from for example Na-salt regeneration tank 521, and the NH₄⁺ polish column 520 may be regenerated using NH₄-salts, from for example NH₄-salt regeneration tank 531, as appropriate. The excess Na⁺-salts or NH₄⁺-salts from the primary IEX column 550 can be sent out for waste treatment as shown in FIG. 3.

FIG. 4 shows a system similar to the system shown in FIG. 3, except that it is simplified by removal of the Na⁺ and NH₄⁺ polishing columns. The same process as described with respect to FIG. 3 is followed, except passing of the effluents through Na⁺ or NH₄⁺ polishing columns is omitted. This process and system include use of Na-salt and NH₄⁺ salt regeneration flows, from Na-salt regeneration tank 521 and NH₄-salt regeneration tank 531, respectively, for the primary IEX column 550. This embodiment is particularly useful where higher concentrations of aluminum remaining in the effluent returned to the coating bath are acceptable to shorten cycle time or to reduce capital cost of the system.

FIG. 5 shows another embodiment of the present invention with two ion exchange columns 500 and 510, in combination with the coating bath system of FIG. 1. Rectifier 2000 and heat exchanger 300 are not shown in the FIG. 5 view. FIG. 5 shows optional components of the system, including a surge tank 450 to which the second effluent, i.e. cleaned bath flows after leaving ion exchange column 510, and a check filter 420 useful to prevent any solids formed in the surge tank 450 from flowing back into the bath. In addition, the FIG. 5 schematic shows a series of feed/transfer pumps 810, 820 and 830, and a series of valves 701, 702, 703, 704, 705, 706, 707, 708, 709, 710, 711, 712, 713, 714 and 715 in the system for control of movement of the fluids through the system. The IEX columns 500 and 510 each have a control valve system, 900 and 910 respectively, shown schematically as a rectangle on top of each of the IEX columns in FIG. 5. These commercially available control valve systems comprise multiple inlet and outlet ports with internal passages and ducts that are opened and closed by control valves via an electronic controller programmed to create the proper flow scheme for all or portions of the IEX cycle.

In carrying out the present invention, the aluminum concentration in the coating bath solution is preferably maintained at a low, non-zero amount; as the bath is used aluminum builds up from amounts of as low as 1 ppm and will continue to increase to amounts of 4000 ppm and higher due to dissolution of Al from the substrate during coating deposition. Eventually, the aluminum in the coating bath begins to affect coating quality. Through use of the instant cleaning process, Al concentration may be maintained in a range of at least about, 100, 120, 140, 150, 160, 170, 180, or 190 ppm to no more than about 4000, 3500, 3000, 2500, 2000, 1500, 1000, 500, 250 or 200 ppm. Desirably the aluminum concentration in the working coating bath is maintained at about 200 to about 3000 ppm, more preferably from about 500 to about 1500 ppm.

The size of the IEX resin bed depends on the expected amount of aluminum to be removed from the liquid feed from the coating bath. The IEX resin bed size may be adjusted to a range of about 0.05 to 1.0 liters of resin per gram of aluminum to be removed, more preferably from 0.15 to 0.35 liters of resin per gram of aluminum to be removed. Desirably, the IEX resin bed size can be at least about 0.04, 0.05, 0.06, 0.07, 0.08, 0.09, 0.10, 0.11, 0.12, 0.13, 0.14, or 0.15 liters of resin per gram of Al to be removed and at least for economy and for a smaller apparatus size, not more than about 1, 0.75, 0.50, 0.40, 0.35, 0.30, 0.25, 0.20 liters of resin per gram of Al to be removed.

The flow rate of the feed into the IEX columns may range from 1 to 50 bed volumes per hour and more preferably from 5 to 25 bed volumes per hour. Desirably, the feed flow rate is at least about 0.5, 1, 2, 3, 4, 5, 6, 7 or 8 bed volumes/hour and not more than about 50, 45, 40, 35, 30, 25, 20, 15 or 10 bed volumes/hour.

Particle size to be removed by the filtration or centrifugation may range from 0.1 to 50 microns, more preferably from 0.5 to 20 microns.

As described above, the present process utilizes as the primary IEX column 550, a resin that is a strong acid cation exchange resin that starts in the Na⁺ form; alternatively, the process may utilize a first column of resin that starts in the H+ form to remove NH₄⁺ and a second column of resin in the Na⁺ form to remove H⁺. Suitable examples of strong acid cation exchange resins in H⁺ or Na⁺ form include Amberjet 1200H, Dowex G26H, Dowex Marathon 650C, Dowex Marthon C, commercially available from The Dow Chemical Co.; Lewatit MonoPlus S 108H, 200 KR and 215 KR, commercially available from Lanxess Aktiengesellschaft; Diaion™ PK208, SK102, SK104, SK1B, SK110, SK116, UBK08, UBK10, UBK12, UBK16, commercially available from Mitsubishi Chemical Corporation; and Purolite C100X16MBH, C160H, C100, C100E, C100X10, C120E, Puropack PPC100H and Purofine PFC100, commercially available from Lenntech BV. Porous or gel matrix resins with a matrix that is styrene-divinylbenzene (DVB) base with sulfonic acid or similar functional groups may be used. Strong acid cation exchange resins in the Na⁺ form are preferred.

The flow rate of the regenerant through the IEX columns may range from 1 to 10 bed volumes per hour, more preferably from 2 to 5 bed volumes per hour. The number of equivalents of cations in the regenerant solution per equivalent in the resin bed may range from 1 to 10, more preferably from 1.5 to 3.0. Desirably, the number of equivalents of cations in the regenerant solution per equivalent in the resin bed may range from at least about 0.5, 0.75, 1.0, 1.25, 1.5, 1.75, 2.0, 2.25, 2.5 or 2.75 equivalents of regenerant cations per equivalent of resin bed cations and at least for economy not more than about 15, 13, 11, 10, 9, 8, 7, 6, 5, 4 or 3 equivalents of regenerant cations per equivalent of resin bed cations.

Description is made herein with reference to anodization bath solutions but will be understood by those skilled in the art to apply to other coating baths having comparable chemistry or components and/or dissolved Al to be removed from the coating bath.

### EXAMPLES

### Comparative Examples

The cryolite precipitation process was not the first process evaluated to remove Al from anodizing coating baths containing Al, Ti and other various other components. Earlier attempts to separate the Al are briefly described below:

Cation exchange with various types of resins (i.e. strong acid cation (SAC), weak acid cation, iminodiacetate, aminophosphonic acid, etc.) were tested, but none exhibited any capacity for Al since the Al bond energy in the fluoroaluminate anion (i.e. AlF₆⁻³) that exists in solution is far greater than that of any Al species that might bind to the functional group on the IEX resin. Experiments often give the impression that some Al is removed but careful mass balances showed the drops in [Al] in these experiments were due to the water of dilution from the resin beads when relatively large resin-to-solution ratios were tested in batch experiments.

Anion exchange with various types of resins (i.e. strong base anion, moderate base anion, weak base anion, etc.) was tested. However, all these resins had a greater affinity for the fluorotitanate anion (i.e. TiF₆⁻²) in solution than the fluoroaluminate anion. As such, all anion exchange processes removed more fluorotitanate than the fluoroaluminate making direct purging of the bath to drain more efficient. Also, both the fluoroaluminate and fluorotitanate anions precipitate at pH's>˜4. As such, regenerating an anion resin proved difficult to do without precipitation occurring inside the resin beads, which is undesirable.

Low temperature precipitation was attempted by cooling the used coating bath to −5° C. and crystals that formed were slightly enhanced in the ammonium fluoroaluminate compared to the ammonium fluorotitanate but not enough to justify further work.

Salts were precipitated from the bath by tiny, e.g. dropwise, incremental additions of 1% NH₃. The least soluble species in this experiment was found to be Ti₃(PO₄)₄ which would precipitate first, which data is consistent with the EDAX of precipitate in the working coating baths. Precipitation of Ti from the bath is undesirable, since this is a primary element in the anodic coating bath tested.

### Comparative Example 1—Screening IEX Experiment

Seventeen resins of 9 different types/functionalities were tested for viability in removal of Al without accompanying loss of Ti. In this experiment, 5 mls of anion resins or 10 mls of cation resins were mixed with 120 mls of a used anodic coating bath containing ˜470 ppm Al and ˜4980 ppm Ti. After shaking the samples and letting them sit overnight, decanted the liquid and submitted it for Inductively Coupled Plasma (ICP) analysis. Results are shown below in Table A.

TABLE A

| | | Vol | | | | | |
|---|---|---|---|---|---|---|---|
| | | Resin | Ti % | PO₄ % | Al % | Selectivity | Selectivity |
| Resin | Type | (mls) | Removed | Removed | Removed | Al/Ti | Al/PO₄ |
| S4428 | MBA | 5 | 47.8 | 34.3 | 8.1 | 0.096 | 0.169 |
| A870 | MBA | 5 | 31.7 | 13.3 | 5.3 | 0.121 | 0.367 |
| IRA958 | SBA | 5 | 19.3 | 7.4 | 5.5 | 0.245 | 0.732 |
| PSR2 | SBA | 5 | 12.9 | 3.1 | 2.1 | 0.147 | 0.683 |
| SBG1-C1 | SBA | 5 | 32.5 | 5.6 | 4.0 | 0.087 | 0.716 |
| A8071 | SBA | 5 | 31.3 | 4.6 | 3.2 | 0.072 | 0.679 |
| PA308 | SBA | 5 | 23.5 | 6.8 | 6.2 | 0.214 | 0.903 |
| SAR | SBA-2 | 5 | 30.3 | 4.3 | 2.1 | 0.050 | 0.481 |
| A532E | SBA-BF | 5 | 19.5 | 3.7 | 3.4 | 0.146 | 0.916 |
| MP62WS | WBA | 5 | 42.2 | 30.9 | 7.4 | 0.110 | 0.180 |
| S106 | WBA | 5 | 40.6 | 28.4 | 16.2 | 0.283 | 0.486 |
| A847 | WBA | 5 | 40.2 | 28.7 | 8.5 | 0.139 | 0.231 |
| UBK08 | SAC | 10 | 5.0 | 5.6 | 9.6 | 2.003 | 1.800 |
| UBK16 | SAC | 10 | 2.0 | 3.1 | 7.7 | 4.048 | 2.605 |
| S930+ | IDA | 10 | 15.1 | 6.8 | 13.6 | 0.889 | 2.164 |
| S940 | APA | 10 | 5.4 | 9.3 | 7.7 | 1.447 | 0.813 |
| JC800 | WAC | 10 | 7.2 | 4.6 | 5.1 | 0.691 | 1.109 |

The above Table A shows the % of components which were removed and the relative selectivity of each resin for Al/PO₄ and Al/Ti. The Al/Ti selectivity indicates only cation resins had selectivities>1. A selectivity of 1 represents what can be achieved by simply bleeding the bath (i.e. equal % drops for both Al and Ti). Only 3 of 17 resins had selectivity>1. The resins having the greatest selectivity for Al were then investigated in column experiments.

### Comparative Example 2—Column IEX Experiments

Tested the five resins listed in Table B 1, below, in 10 ml columns. All resins were converted to the H-form prior to being used.

TABLE B1

| Resin | Type of Resin | Form |
|---|---|---|
| TP207 | Iminodiacetate (IDA) | H-form |
| WK40 | Weak acid cation (WAC) | H-form |
| S930 | Iminodiacetate (IDA) | H-form |
| MAC3 | Weak acid cation (WAC) | H-form |
| JC800 | Weak acid cation (WAC) | H-form |

Pumped used anodizing bath (470 ppm Al and 4980 ppm Ti) as feed through the columns to saturate the resin. Regenerated columns with ˜5 BV's of HCl and analyzed regenerant effluents by ICP, results are shown in Table B2, below.

TABLE B2

| (ppm) | Ti | Al | PO₄ | Na | SO₄ | Si | K | Ni | Cu | Zn | Mg | Ca |
|---|---|---|---|---|---|---|---|---|---|---|---|---|
| Used Anodizing bath | 3087. | 539. | 2111. | 24. | 26. | 84. | 6. | 1. | <1. | <1. | <1. | <1. |
| Regen TP207 | 112. | 27. | 5. | 5. | <1. | 1. | 1. | 29. | <1. | 29. | 1. | 7. |
| Regen WK40 | 70. | 14. | 8. | 8. | <1. | 1. | 4. | 10. | 4. | 4. | <1. | 2. |
| Regen S930 | 60. | 21. | 5. | 5. | <1. | 3. | 1. | 47. | 1. | 26. | 1. | 7. |
| Regen MAC3 | 56. | 17. | 6. | 7. | <1. | 1. | 3. | 7. | 4. | 3. | <1. | 2. |
| Regen JC800 | 36. | 13. | 6. | 4. | <1. | 2. | 1. | 3. | 4. | 2. | <1. | 2. |

Results in Table B2 showed very little Al and only slightly higher amounts of Ti in the regenerants. Also noted that some tramp metals (e.g. Ni, Zn, etc.) appear in higher quantities in the regenerants than the used anodizing bath, especially those from the iminodiacetate (IDA) columns.

### Comparative Example 3—Column IEX Experiments

Tested the four resins listed in Table C, below, in 10 ml columns. All resins were in the Na-form prior to being used.

TABLE C1

| | | |
|---|---|---|
| S-940 | Aminophosphonic acid (APA) | Na |
| S-930 | Iminodiacetate (IDA) | Na |
| UBK08 | Strong acid cation (SAC 8% XL) | Na |
| UBK16 | Strong acid cation (SAC 16% XL) | Na |

Pumped through ˜70-80 BV's of used anodizing bath as feed (470 ppm Al and 4980 ppm Ti), collected seven cuts of effluent from each column which were then analyzed for Al (by UV-absorbance). Regenerated columns with 10% HCl and analyzed regenerant effluents by ICP and NH₃ electrode. Results are shown below in Table C2.

TABLE C2

| | | | |
|---|---|---|---|
| AR | BR | CR | DR |

Resin

| | UBK16 | UBK08 | S930+ | S940 |
|---|---|---|---|---|
| Total Fluoride (ppm) | <10 | <10 | <10 | <10 |
| Titanium (ppm) | <1 | 4 | <1 | 30 |
| Aluminum (ppm) | 3 | 4 | 10 | <1 |
| Silicon (ppm) | <5 | <5 | <5 | <5 |
| Sodium (ppm) | 7 | 5 | <5 | <5 |
| Phosphate (ppm) | <10 | <10 | <10 | <10 |
| Sulfate (ppm) | <10 | <10 | <10 | <10 |
| Ammonia (ppm) | 4380 | 2500 | <50 | <50 |

Found insignificant amounts of Al or Ti in regenerant cuts but did find NH₃ in both SAC regenerants—enough to saturate the beads. The data above shows that the SAC resins in the Na-form pick up NH₄⁺ very effectively—even at pH ˜2.5.

### Comparative Example 4—Column IEX Experiments

Tested five resins listed below in Table D1, as H-form in 59-73 ml BV columns, carefully quantifying water of dilution in the system.

TABLE D1

| Col-A | Col-B | Col-C | Col-D | Col-E |
|---|---|---|---|---|
| SAC-16% | SAC-8% | WAC | IDA | APA |
| H-form | H-form | H-form | H-form | H-form |
| UBK16 | UBK08 | MAC-3 | S930+ | S940 |

Analyzed multiple effluent cuts for Al by UV-absorbance method. The water of dilution was mathematically factored out of the Al concentrations, and for the H-form IEX resins, Al concentration results show no Al was adsorbed on H-form IEX resin beads.

### Example 1

In a first example showing use of the present invention, a tote of used electrolyte coating bath solution was used as the feed for the bath cleaning system. The used coating bath solution contained 1560 ppm of aluminum and 5730 ppm titanium in solution, both being complexed with fluoride. The suspended solids in this feed were rich in Ti, P, and O as determined by Energy Dispersive X-Ray Spectroscopy (EDAX) and these suspended solids were removed by filtration through a 1-micron filter followed by centrifugation such that the feed to the actual experiment was about 1 nephelometric turbidity units (NTU) compared to 400 NTU for the starting material from the tote. This was done so that there would be no ambiguity whether solids present at the end of the experiment came from the feed or were produced during the experiment.

One hundred milliliter (ml) aliquots of this feed were mixed in four plastic bottles with 5, 10, 15, and 20 ml, respectively, of strong acid cation exchange resin in the Na⁺ form, commercially available from Mitsubishi Chemical Corporation. Almost immediately, a white precipitate formed in each bottle. The bottles were intermittently shaken during the day, but no mixers were used. After sitting overnight, the solids, both dark resin beads and a white powder, were removed from the samples by centrifugation. The resin beads were separated from the white powder by filtration through a 100-micron polypropylene monofilament screen. Then the recovered liquid was analysed as described below.

The initial feed and the recovered fluids from the four IEX treated products were analysed by a battery of tests: pH; aluminum content by a UV-absorbance method as described in Journal (American Water Works Association), Vol. 82, No. 5, pp 71-78 (May 1990); coating bath contents by UV-absorbance method; free fluoride concentrations by a fluoride selective electrode; detection of undissociated HF by a Lineguard 101 meter; Inductively Coupled Plasma (ICP) testing for detecting Al, Ti, Si, Na, K, and PO₄; total fluoride analysis by a Huckabay distillation; and measurement of NH₃ by an electrode to determine NH₄⁺ concentrations. The measurement of NH₃ is taken as the concentration of NH₄⁺ in the sample. Below in Table 1, the results for the ICP analysis and total fluoride are reported. The concentration results presented in Table 1 are corrected for the amount of dilution water added with the resin additionally the % recovery from the feed concentration is presented for each component.

TABLE 1

| | Initial | 5 ml of resin | 10 ml of resin | 15 ml of resin | 20 ml of resin |
|---|---|---|---|---|---|
| Component | feed | sample | sample | sample | sample |
| Al ppm | 1560 | 921 | 525 | 398 | 344 |
| Ti ppm | 5730 | 5353 | 4936 | 4967 | 5015 |
| Si ppm | 264 | 240 | 208 | 193 | 189 |
| Na ppm | 35 | 820 | 1266 | 1753 | 2175 |
| K ppm | 24 | 24 | 19 | 17 | 17 |
| PO₄ ppm | 3100 | 2877 | 2468 | 2326 | 2285 |
| NH₃ ppm | 7180 | 3740 | 3365 | 2197 | 2008 |
| Total F⁻ wt. % | 1.66 | 1.37 | 1.24 | 1.19 | 1.14 |
| Al % recovery | 100.0 | 59.0 | 33.7 | 25.5 | 22.0 |
| Ti % recovery | 100.0 | 93.4 | 86.1 | 86.7 | 87.5 |
| Si % recovery | 100.0 | 91.1 | 78.7 | 73.0 | 71.4 |
| Na % recovery | 100.0 | 2342.0 | 3616.0 | 5008.0 | 6213.0 |
| K % recovery | 100.0 | 98.5 | 79.1 | 72.1 | 69.3 |
| PO₄ % recovery | 100.0 | 92.8 | 79.6 | 75.0 | 73.7 |
| NH₃ % recovery | 100.0 | 52.1 | 46.9 | 30.6 | 28.0 |
| Total fluoride % | 100.0 | 82.3 | 75.0 | 71.7 | 68.8 |
| recovery | | | | | |

The results show the benefits of the current process. The amount of aluminum left in the recovered liquid was dramatically reduced showing that the resin was able to remove aluminum from the bath solution. Almost 80% of the aluminum was removed by the 20 ml resin sample. The loss of aluminum in the various samples closely corresponds with the loss of NH₄⁺ in the same samples due to the ion exchange reaction. In addition, one sees a dramatic rise in the Na⁺ concentrations as expected since it is being displaced from the resin by the NH₄⁺. Importantly, the ion exchange resin did not remove most of the other main components of Ti, Si, K, PO₄, and total fluoride. These were all retained at a concentration of about 70% or greater as compared to the original feed. The amount of Ti was retained at better than 85% which is significant for repeated uses of the cleaned bath solution. Losses of Ti and PO₄ are small and appear to be due to interstitial liquid not recovered from centrate when the cryolite was removed.

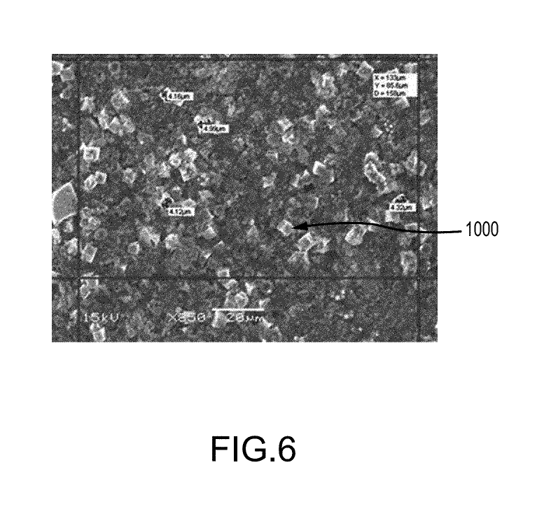

In Table 2 below are present the values for total milligrams (mg) in the solutions, millimoles in solutions (mM), change (Δ) of moles in the solutions after passing through the resins, and the mole ratio of ΔF/ΔAl in the solutions. A mass balance analysis of the results from ICP and total fluoride shows that the molar ratio change of F to Al is consistent with precipitation of Na₃AlF₆ since the molar ratio of Δ F to Δ Al is approximately 6 in all the samples. In addition, EDAX analysis of the solid precipitates, which were largely cubic crystals of 4 to 6 microns, showed they were rich in Na, Al, F. The precipitates also contained a little Si. A scanning electron micrograph picture of the precipitate from the 10 ml of resin sample from this example is shown in FIG. 6. The precipitate shown by the arrow as 1000 shows cubic crystals consistent with cryolite crystal morphology having elemental composition: O 3.22 wt. % and 4.31 atomic %, F 42.62 wt. % and 48.01 atomic %, Na 34.74 wt. % and 32.34 atomic %, Al 17.55 wt. % and 13.92 atomic %, and Si 1.86 wt. % and 1.42 atomic %.

TABLE 2

| | Initial | 5 ml of resin | 10 ml of resin | 15 ml of resin | 20 ml of resin |
|---|---|---|---|---|---|
| Component | feed | sample | sample | sample | sample |
| Al mg | 158.3 | 93.5 | 53.3 | 40.4 | 34.9 |
| Ti mg | 581.6 | 543.4 | 501.0 | 504.2 | 509.0 |
| Si mg | 26.8 | 24.4 | 21.1 | 19.6 | 19.1 |
| Na mg | 3.6 | 83.2 | 128.5 | 177.9 | 220.7 |
| K mg | 2.4 | 2.4 | 1.9 | 1.8 | 1.7 |
| PO₄ mg | 314.6 | 292.0 | 250.5 | 236.2 | 232.0 |
| NH₃ mg | 728.7 | 379.6 | 341.5 | 223.0 | 203.8 |
| Total fluoride mg | 1684.8 | 1387.2 | 1263.1 | 1208.2 | 1159.8 |
| Al mM | 5.87 | 3.46 | 1.98 | 1.50 | 1.29 |
| Ti mM | 12.15 | 11.35 | 10.47 | 10.53 | 10.63 |
| Si mM | 0.95 | 0.87 | 0.75 | 0.70 | 0.68 |
| Na mM | 0.15 | 3.62 | 5.59 | 7.74 | 9.60 |
| K mM | 0.06 | 0.06 | 0.05 | 0.04 | 0.04 |
| PO₄ mM | 3.31 | 3.07 | 2.64 | 2.49 | 2.44 |
| NH₃ mM | 42.79 | 22.29 | 20.05 | 13.09 | 11.97 |
| Total fluoride mM | 88.68 | 73.01 | 66.48 | 63.60 | 61.05 |
| Al Δ mM | 0.00 | 2.40 | 3.89 | 4.37 | 4.57 |
| Ti Δ mM | 0.00 | 0.80 | 1.68 | 1.62 | 1.52 |
| Si Δ mM | 0.00 | 0.09 | 0.20 | 0.26 | 0.27 |
| Na Δ mM | 0.00 | −3.47 | −5.43 | −7.59 | −9.45 |
| K Δ mM | 0.00 | 0.00 | 0.01 | 0.02 | 0.02 |
| PO₄ Δ mM | 0.00 | 0.24 | 0.68 | 0.83 | 0.87 |
| NH₃ Δ mM | 0.00 | 20.50 | 22.74 | 29.70 | 30.82 |
| Total fluoride Δ mM | 0.00 | 15.67 | 22.20 | 25.09 | 27.63 |
| Mole ratio: ΔF/ΔA1 | | 6.52 | 5.70 | 5.74 | 6.04 |

### Example 2

Example 2 used the same coating bath feed and preparation as described in Example 1. In this experiment, two small IEX columns made from clear Schedule 40, ½″ PVC pipe, inner diameter of 0.608 inches by 18 inches tall were filled with 66 mls of a strong acid cation resin in the Na⁺ form, commercially available from Mitsubishi Chemical Corporation. This produced a resin bed length of approximately 14 inches. The resin beds were rinsed with reverse osmosis (RO) water until their effluent conductivities were <20 micro Siemens/cm. The water level in each column was then drained down to approximately ¾″ above the resin beads before starting the feed so as to minimize the amount of dilution in the first effluent samples. The coating bath feed was pumped in a downward flow through each column at approximately 7.7 mls/min, which was equal to 7 bed volumes (BV)/hour. A total of 12 samples of each column effluent were collected at 7-minute intervals. After feeding, the columns were rinsed with RO water at the same flow rate for 15 minutes.

Precipitates formed in most of the effluent samples, almost immediately for the early samples and overnight for the later samples. This indicates that the precipitation process will require some time to occur. The solids in the first sample were fluffy while the solids in later samples were more “chippy”, e.g. larger firmer particles. Prior to analyses listed below, the solids in all of the samples were removed by centrifugation. A total of 28 samples, feed+13 effluent samples, from each column were analysed by the same tests as in Example 1.

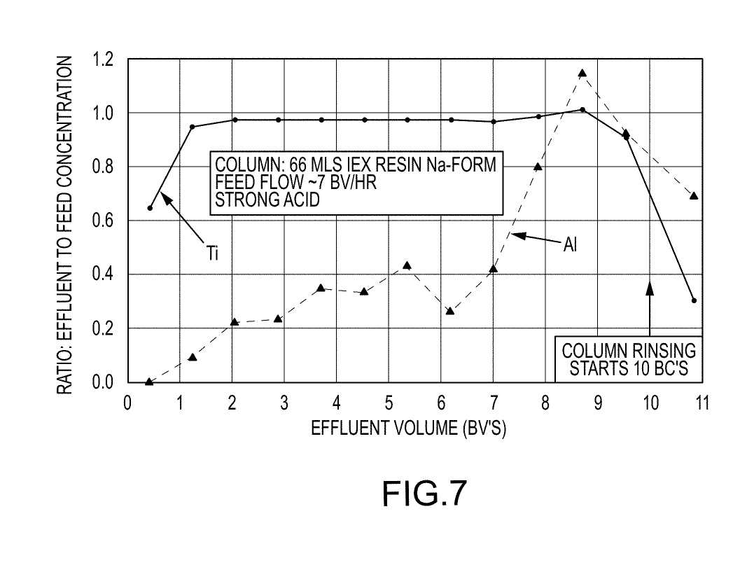

FIG. 7 is a graph showing recovery of Al or Ti in the effluent. As shown in Example 1 the amount of Ti recovered is very high and little is lost in the IEX columns. By way of contrast the amount of Al recovered is dramatically decreased as it is precipitated out of the solution.

The volumes of feed and resin in Example 2 were chosen such that the resin bed should have been exhausted, all of the Na⁺ in the resin beads replaced by NH₄⁺, at about 10 BV's of feed assuming 100% efficiency of exchange. The same data set generated a mass balance analysis which indicated that the net process removed about 5.7 grams of Al per liter of resin.

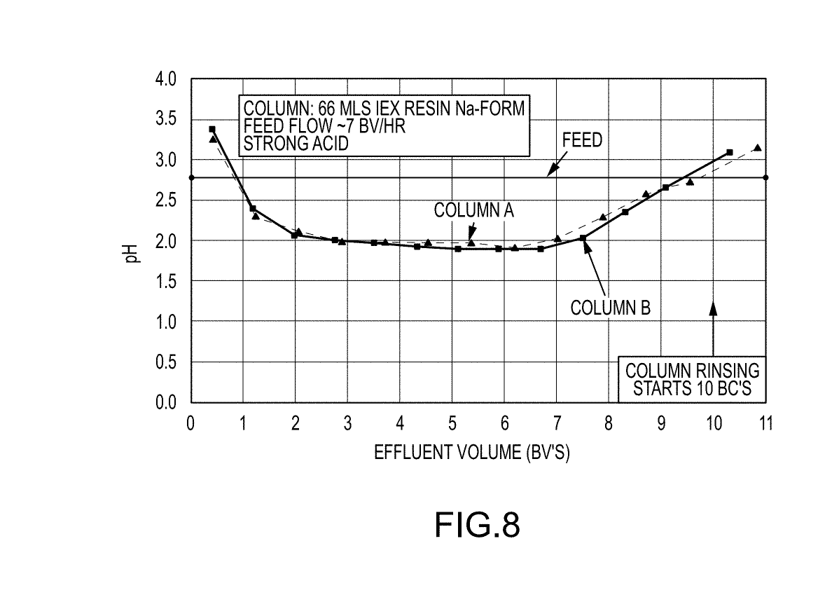

The graph in FIG. 8 shows that either the IEX of Na⁺ for NH₄⁺ or the precipitation of cryolite is accompanied by a drop in pH of the samples. This is unexpected, beneficial, and significant since even slight increases in pH may result in the undesirable precipitation of the fluorotitanate from the bath. The fact that the pH dropped further assures that the titanium is not lost from the bath solution.

After rinsing, one column was regenerated with 5 BV's of 10% HCl followed by neutralization with NaOH and the other column was regenerated with 5 BV's of 15% NaCl to see if one mode of regeneration is more efficient than the other. The flow to each column was approximately 2.8 BV/hour. The sample bottles were weighed before and after collection so an accurate mass balance could be made. The analytical results from the regenerant samples showed that the NaCl regenerant performed as calculated, providing satisfactory results close to theoretical and good rinseability from the IEX column. The HCl regenerant analysis showed total cations removed were higher than theoretical. The data suggests that some cryolite was precipitated inside the IEX column, which was then dissolved by the HCl regenerant.

### Example 3

The main purpose of this example is to complete all steps of the bath cleaning process and then use the cleaned bath to coat test coupons to confirm usefulness of the process. To do this, a larger IEX column was needed so the height of the IEX column was increased to 67 inches. It was filled with 250 mls of a strong acid cation resin in Na⁺ form. This produced an IEX resin depth of about 53.5 inches. The experimental protocol was similar to that followed in Example 2. Approximately 15 BV's of used coating bath feed were pumped in a downward flow through the column at a rate of 47 mls/min, approximately 11.3 BV/hour. Thirteen samples of effluent were collected at six-minute intervals.

The column was then rinsed with RO water for 15 minutes and then regenerated with 6 BV's of 10% NH₄⁺ Cl pumped at 3.3 BV/hour. This amount of regenerant was in excess. The effluent samples were analyzed by UV-absorbance method.

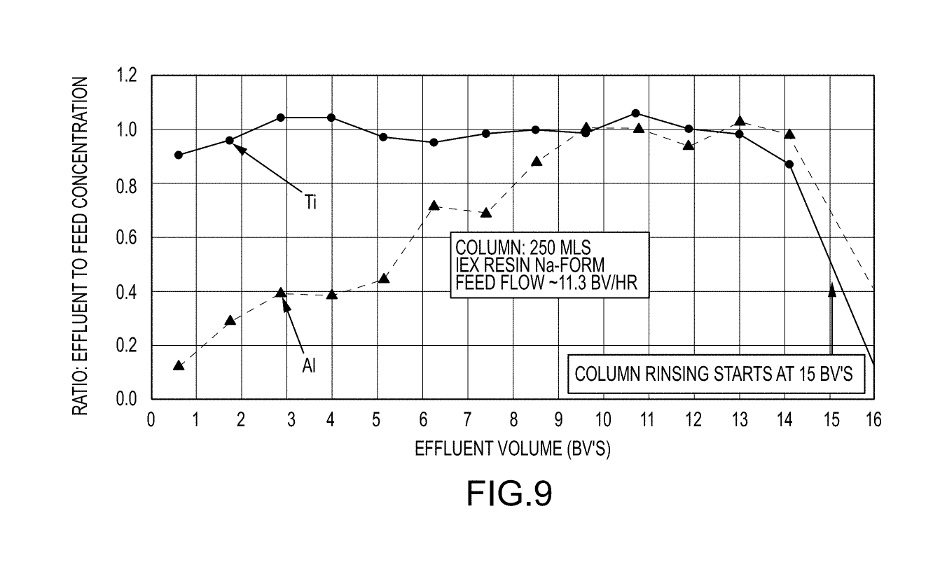

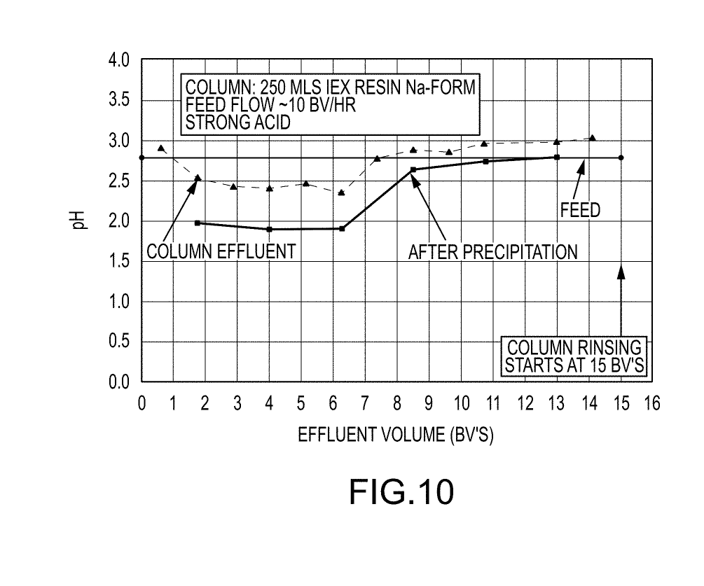

The graph in FIG. 9 shows Al removal with little or no loss of the Ti in the bath, similar to what was seen in the experiments of Example 2. With the taller, more efficient column, note the effluent Al concentration matches the feed concentration, y axis=1.0, very close to 10 BV's which is what was expected. FIG. 10 is a graph of the pHs of the samples taken immediately out of the IEX column and the next day after precipitation has taken place. The results indicate the pH drops during both the IEX step and during the precipitation step.

Since each effluent sample was about 280 mls, the cryolite was separated by filtration on #410 filter paper, which has a nominal rating of 1 micron. The filter cakes were not washed but were allowed to air dry for several days. For effluent samples #1 through #8, the cumulative weight of the Al removed was calculated to be 1.33 gm while the measured weights of the air dried filter cakes summed to 11.54 gm. This gives a weight ratio for the cakes to removed Al=11.54/1.33=8.66, which is quite close to the molecular weight ratio of cryolite to Al, 209.94/26.98=7.78, giving more evidence that the precipitate is cryolite, or contains mostly cryolite, with a small amount of occluded mother liquor.

Three samples of liquids from the IEX cleaning process were tested for coating quality: A) a portion of the original feed of used coating bath filtered to remove solids; B) a coating bath after the first IEX to Na⁺ form generated a first effluent and filtration of the first effluent to remove cryolite to make the supernatant effluent which was used as the coating bath; and C) a coating bath after the second IEX changing from Na⁺ form back to NH₄⁺ form plus minor replenishment to correct for water of dilution from the IEX treatment. The three sample coating baths were used in an anodization process to coat small coupons of aluminum alloys 413 and 6061 using identical electro ceramic coating parameters as known in the art.

Both first and second IEX treatments were performed using identical flows, 47 mls/min=about 11.3 BV/hour. A total of 6 effluent samples were collected at six-minute intervals.

With this slightly replenished bath, small coupons of aluminum alloys 413 and 6061 were coated using standard electro ceramic coating parameters. The coating thicknesses was determined by a Portaspec wavelength dispersion X-ray fluorescence spectrophotometer and the results are summarized in Table 3 below. Performance is summarized with indicators as follows: “X” indicates unacceptable coating weight; “O” indicates low coating weight; and “+” indicates excellent coating weight.

TABLE 3

| | | | | Aluminum Alloy | |
|---|---|---|---|---|---|
| Bath Sample | [NH₄⁺] | [Na⁺] | [Al] | Type of Coupon | Performance |
| A | High | Low | High | 413 | ◯ |
| B | Low | High | Low | 413 | X |
| C | High | Low | Low | 413 | + |
| A | High | Low | High | 6061 | ◯ |
| B | Low | High | Low | 6061 | X |
| C | High | Low | Low | 6061 | + |

The data clearly show that the bath in the Na⁺ form gives an unacceptable coating which is consistent with expectations. The cleaned bath was able to produce very good coatings having very good coating thicknesses. These results demonstrate the usefulness of the present process for cleaning and restoring coating bath solutions.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method for removing aluminum from an anodization bath solution comprising the steps of:
a) providing an aqueous acidic anodization solution containing NH₄⁺ and aluminum and fluoride;
b) passing the anodization solution through a strong acid cation exchange column in the Na⁺ form and exchanging Na⁺ for NH₄⁺ in the anodization solution and collecting the effluent;
c) removing formed insoluble cryolite, Na₃AlF₆, from the effluent of step b); and
d) taking the effluent from step c), after removing the cryolite, and passing it through a strong acid cation exchange column in the NH₄⁺ form and exchanging NH₄⁺ for Na⁺ in the effluent and collecting the resulting effluent.

2. The method as recited in claim 1 wherein the anodization solution comprises water-soluble complex fluorides and/or oxyfluorides of elements selected from the group consisting of Ti, Zr, Hf, Sn, Al, Ge, B, and mixtures thereof; and wherein the anodization solution further comprises phosphorous containing acids, salts or mixtures thereof.

3. The method as recited in claim 1 wherein the anodization solution in step a) contains more than 200 parts per million (ppm) of aluminum.

4. The method as recited in claim 1 wherein the cation exchange column in step b) comprises from 0.05 to 1.0 liters of cation exchange resin per gram of aluminum to be removed from the anodization solution from step a).

5. The method as recited in claim 1 wherein a rate of flow of the anodization solution through the cation exchange column in step b) is from 2 to 50 bed volumes per hour.

6. The method as recited in claim 1 wherein removal of cryolite in step c) comprises filtering the cryolite from the effluent or separation from the effluent by a centrifugation process.

7. The method as recited in claim 1 wherein step c) further comprises aging the effluent from step b) in a tank for a period of time of at least 1 hour to allow for formation of the cryolite in the effluent prior to removing it in step c).

8. The method as recited in claim 7 wherein said period of time of aging the effluent from step b) comprises a sufficient amount of time to allow for formation of cryolite particles having a size of from 0.1 to 50 microns.

9. The method as recited in claim 1 wherein step d) comprises passing the effluent from step c) through the same cation exchange column as in step a), which was has been regenerated to be in the NH₄⁺ form, to exchange NH₄⁺ for Na⁺ in the effluent and collecting the resulting effluent.

10. The method as recited in claim 9, wherein the anodization solution in step a) is passed through the cation exchange column in a first direction and wherein the effluent from step d) is passed through the same cation exchange column in a counter current direction to step a).

11. The method as recited in claim 1 further comprising passing the effluent from step b) through a Na⁺ polishing ion exchange column prior to step c).

12. The method as recited in claim 1 further comprising passing the resulting effluent from step d) through a NH₄⁺ polishing ion exchange column.

13. The method as recited in claim 1 wherein the cation exchange column in step a) is a different cation exchange column from the cation exchange column utilized in step d).

14. The method as recited in claim 1 further comprising the step of regenerating the cation exchange column from step a) to the Na⁺ form by passing a regenerating solution containing at least one regenerant salt selected from the group consisting of NaCl, Na₂SO₄, NaHSO₄, Na₃PO₄, Na₂HPO₄, NaH₂PO₄, and mixtures thereof through the cation exchange column.

15. The method as recited in claim 14 wherein an equivalents excess of regenerant equivalents to cation resin equivalents is in the range of from 1-fold to 10-fold excess.

16. The method as recited in claim 14 wherein a flow rate of the regenerating solution through the cation exchange column is from 2 to 50 bed volumes per hour.

17. The method as recited in claim 1 further comprising the step of regenerating the cation exchange column from step d) to the NH₄⁺ form by passing a regenerating solution containing at least one regenerant salt selected from the group consisting of (NH₄)₂HPO₄, (NH₄)H₂PO₄, (NH₄)₂SO₄, (NH₄)HSO₄, (NH₄)Cl, and mixtures thereof through the cation exchange column.

18. The method as recited in claim 17 wherein an equivalents excess of regenerant equivalents to cation resin equivalents is in the range of from 1-fold to 10-fold excess.

19. The method as recited in claim 17 wherein a flow rate of the regenerating solution through the cation exchange column is from 2 to 50 bed volumes per hour.

20. The method as recited in claim 1 wherein the resulting effluent after step d) has an aluminum content of from 200 to 3000 parts per million.

21. The method as recited in claim 14 further comprising a periodic step of regenerating the cation exchange column from step a) with HCl thereby removing precipitated cryolite from the cation exchange column followed by neutralizing with NaOH or NH₄OH thereby regenerating to the Na⁺ form or NH₄⁺ form.

22. A system for removing aluminum from coating bath solutions comprising:
a) a resin bed or IEX column hydraulically connected to a coating tank for coating bath solutions comprising dissolved aluminum, the resin bed or IEX column containing a strong acid cation exchange resin having Na+ present as the exchange ion for removing NH4+ from the coating bath solution and adding Na+ to form a first effluent;
b) a precipitation tank, hydraulically connected to the resin bed or IEX column, for receiving a first effluent from the resin bed or IEX column and precipitating insoluble aluminum species;
c) a solids separation device, hydraulically connected to the precipitation tank and capable of removing insoluble precipitates from the first effluent, optionally by filtration and/or centrifugation to thereby form a supernatant liquid;
d) a strong acid cation exchange resin having NH4+ as the exchange ion, hydraulically connected to the solids separation device, for removing Na+ and adding NH4+ to the supernatant liquid, to thereby form a second effluent, comprising less dissolved aluminum than the coating bath solution, and optionally hydraulically connected to the coating tank for return of the second effluent thereto.

23. The system as recited in claim 22 wherein the resin bed or IEX column in a) also functions as a resin bed or IEX column containing the strong acid cation exchange resin having NH4+ as the exchange ion of d).

24. The system as recited in claim 22 further comprising a second resin bed or IEX column containing the strong acid cation exchange resin having NH4+ as the exchange ion of d) different from the resin bed or IEX column of a).

25. The system as recited in claim 22 further comprising:
an NH4+ polishing column, for further reducing NH4+ in the first effluent, positioned between and hydraulically connected to a) and b); and/or
a Na+ polishing column, for further reducing Na+ in the supernatant, positioned between and hydraulically connected to d) and the coating tank.

26. The system as recited in claim 22 wherein one or both of the resin bed or IEX columns comprise from 0.05 to 1.0 liters of strong acid cation exchange resin per gram of aluminum to be removed from the coating bath solution.

27. The system as recited in claim 22 further comprising one or more feed/transfer pumps and valves for control of movement of fluids through the system and capable of providing a rate of flow of the coating bath solution through the resin bed or IEX column of a) at from 2 to 50 bed volumes per hour.
